(19) United States
(12) Patent Application Publication
(10) Pub. No.: US 2024/0330070 A1
(43) Pub. Date: Oct. 3, 2024

(54) SYSTEM AND METHOD TO SWITCH OPERATING MODES IN A PARTITIONED SYSTEM

(71) Applicant: Lenovo Enterprise Solutions (Singapore) Pte. Ltd., New Tech Park (SG)

(72) Inventors: Gary D. Cudak, Raleigh, NC (US); Pravin S. Patel, Cary, NC (US); Mehul Shah, Austin, TX (US); James Parsonese, Cary, NC (US)

(21) Appl. No.: 18/129,596

(22) Filed: Mar. 31, 2023

(51) Int. Cl. G06F 9/50; G06F 9/4401

(52) U.S. Cl. CPC G06F 9/5077; G06F 9/4405; G06F 9/5027; G06F 9/442

(57) ABSTRACT

A method for automatically switching between partition configurations at a scheduled time period includes storing, at a service processor, a plurality of partition configurations for a computing system, the plurality of partition configurations allocating hardware resources of the computing system. The method includes associating a configuration schedule with the plurality of partition configurations, where each of the plurality of partition configurations is associated with a scheduled time period, and booting the computing system to a particular partition configuration at a particular scheduled time period corresponding to the particular partition configuration.

### FIELD

The subject matter disclosed herein relates to partition management and more particularly relates to switching operating modes in a partitioned system.

### BACKGROUND

In some scenarios, a system administrator or other user may want to run a partitioned system in different operating modes.

### BRIEF SUMMARY

A method for automatically switching between partition configurations at a scheduled time period is disclosed. An apparatus and computer program product also perform the functions of the method. The method includes storing, at a service processor, a plurality of partition configurations for a computing system, the plurality of partition configurations allocating hardware resources of the computing system. The method includes associating a configuration schedule with the plurality of partition configurations, where each of the plurality of partition configurations is associated with a scheduled time period, and booting the computing system to a particular partition configuration at a particular scheduled time period corresponding to the particular partition configuration.

An apparatus for automatically switching between partition configurations at a scheduled time period includes a processor and a non-transitory computer readable storage media storing code, the code being executable by the processor to perform operations including storing, at a service processor, a plurality of partition configurations for a computing system, the plurality of partition configurations allocating hardware resources of the computing system. The operations further include associating a configuration schedule with the plurality of partition configurations, where each of the plurality of partition configurations is associated with a scheduled time period, and booting the computing system to a particular partition configuration at a particular scheduled time period corresponding to the particular partition configuration.

A computer program product for automatically switching between partition configurations at a scheduled time period includes a non-transitory computer readable storage medium storing code, the code being configured to be executable by a processor to perform operations including storing, at a service processor, a plurality of partition configurations for a computing system, the plurality of partition configurations allocating hardware resources of the computing system. The operations further include associating a configuration schedule with the plurality of partition configurations, where each of the plurality of partition configurations is associated with a scheduled time period, and booting the computing system to a particular partition configuration at a particular scheduled time period corresponding to the particular partition configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a computing system for automatically switching between partition configurations at a scheduled time period, according to various embodiments;

FIG. 2 is a schematic block diagram illustrating an apparatus for automatically switching between partition configurations at a scheduled time period, according to various embodiments;

FIG. 3 is a schematic block diagram illustrating an operating mode, according to various embodiments;

FIG. 4 is a schematic block diagram illustrating another operating mode, according to various embodiments;

FIG. 5 is a schematic block diagram illustrating a configuration schedule, according to various embodiments;

FIG. 6 is a schematic flow chart diagram illustrating a method for automatically switching between partition configurations at a scheduled time period, according to various embodiments; and

FIG. 7 is a schematic flow chart diagram illustrating another method for automatically switching between partition configurations at a scheduled time period, according to various embodiments.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R. Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

In a partitioned system, computing resources may be allocated to different partitions. In some scenarios, a system administrator or other user may want to run a partitioned system in different modes. For example, a computing system may operate in a partitioned mode during the day, to host accounting or other VMs on one partition, while running analytics on another partition. However, at night, it may be preferred to reboot the computing system into a two socket (“2S”) configuration, to enable running the analytics at a higher rate. Disclosed herein are methods, systems, apparatuses, and computer program products that automatically set different partition settings to engage different operating modes at various predetermined times.

A method for automatically switching between partition configurations at a scheduled time period may include storing, at a service processor, a plurality of partition configurations for a computing system, the plurality of partition configurations allocating hardware resources of the computing system. The method includes associating a configuration schedule with the plurality of partition configurations, where each of the plurality of partition configurations is associated with a scheduled time period, and booting the computing system to a particular partition configuration at a particular scheduled time period corresponding to the particular partition configuration.

In some embodiments, the method further includes running a real-time clock (“RTC”) at the service processor. In such embodiments, booting the computing system to the particular partition configuration at the particular scheduled time period may be based on an output of the RTC. In some embodiments, booting the computing system to the particular partition configuration at the particular scheduled time period may include shutting down the computing system at a predetermined time prior to a beginning of a next scheduled time period, switching to the particular partition configuration, and re-booting the computing system.

In certain embodiments, the computing system includes a FPGA coupled to the service processor. In such embodiments, shutting down the computing system at the predetermined time may include signaling the FPGA to power down all active partitions of the computing system and to reconfigure computing system according to the particular partition configuration. In some embodiments, at least one of the plurality of partition configurations includes a multi-partition configuration having multiple partitions, where the hardware resources of the computing system are shared among the multiple partitions. In certain embodiments, each of the multiple partitions may include a processor executing an instance of an operating system. In certain embodiments, the method may include running different operating systems on at least two of the multiple partitions.

In certain embodiments, the method may include performing hardware virtualization while the multi-partition configuration is active. In certain embodiments, the method may include running a virtual machine on at least one partition while the multi-partition configuration is active. In some embodiments, at least one of the plurality of partition configurations includes a multi-socket configuration. In some embodiments, the method further includes storing a computer image associated with each of the plurality of partition configurations. In some embodiments, associating the configuration schedule with the plurality of partition configurations includes dividing a day into a plurality of timeframes and assigning each of the plurality of timeframes to one of the plurality of partition configurations. In some embodiments, the service processor includes a datacenter-ready secure control module (“DC-SCM”) or a baseboard management controller (“BMC”).

An apparatus for automatically switching between partition configurations at a scheduled time period may include a processor and a non-transitory computer readable storage media storing code, the code being executable by the processor to perform operations including storing, at a service processor, a plurality of partition configurations for a computing system, the plurality of partition configurations allocating hardware resources of the computing system. The operations further include associating a configuration schedule with the plurality of partition configurations, where each of the plurality of partition configurations is associated with a scheduled time period, and booting the computing system to a particular partition configuration at a particular scheduled time period corresponding to the particular partition configuration.

In some embodiments, the operations further include running a RTC at the service processor. In such embodiments, booting the computing system to the particular partition configuration at the particular scheduled time period may be based on an output of the RTC. In some embodiments, booting the computing system to the particular partition configuration at the particular scheduled time period may include shutting down the computing system at a predetermined time prior to a beginning of a next scheduled time period, switching to the particular partition configuration, and re-booting the computing system.

In certain embodiments, the computing system includes a FPGA coupled to the service processor. In such embodiments, shutting down the computing system at the predetermined time may include signaling the FPGA to power down all active partitions of the computing system and to reconfigure computing system according to the particular partition configuration. In some embodiments, at least one of the plurality of partition configurations includes a multi-partition configuration having multiple partitions, where the hardware resources of the computing system are shared among the multiple partitions. In certain embodiments, each of the multiple partitions may include a processor executing an instance of an operating system. In certain embodiments, the operations may include running different operating systems on at least two of the multiple partitions.

In certain embodiments, the operations may include performing hardware virtualization while the multi-partition configuration is active. In certain embodiments, the operations may include running a virtual machine on at least one partition while the multi-partition configuration is active. In some embodiments, at least one of the plurality of partition configurations includes a multi-socket configuration. In some embodiments, the operations further include storing a computer image associated with each of the plurality of partition configurations. In some embodiments, associating the configuration schedule with the plurality of partition configurations includes dividing a day into a plurality of timeframes and assigning each of the plurality of timeframes to one of the plurality of partition configurations. In some embodiments, the service processor includes a DC-SCM or a BMC.

A computer program product for automatically switching between partition configurations at a scheduled time period may include a non-transitory computer readable storage medium storing code, the code being configured to be executable by a processor to perform operations including storing, at a service processor, a plurality of partition configurations for a computing system, the plurality of partition configurations allocating hardware resources of the computing system. The operations further include associating a configuration schedule with the plurality of partition configurations, where each of the plurality of partition configurations is associated with a scheduled time period, and booting the computing system to a particular partition configuration at a particular scheduled time period corresponding to the particular partition configuration.

In some embodiments, the operations further include running a RTC at the service processor. In such embodiments, booting the computing system to the particular partition configuration at the particular scheduled time period may be based on an output of the RTC. In some embodiments, booting the computing system to the particular partition configuration at the particular scheduled time period may include shutting down the computing system at a predetermined time prior to a beginning of a next scheduled time period, switching to the particular partition configuration, and re-booting the computing system.

In certain embodiments, the computing system includes a FPGA coupled to the service processor. In such embodiments, shutting down the computing system at the predetermined time may include signaling the FPGA to power down all active partitions of the computing system and to reconfigure computing system according to the particular partition configuration. In some embodiments, at least one of the plurality of partition configurations includes a multi-partition configuration having multiple partitions, where the hardware resources of the computing system are shared among the multiple partitions. In certain embodiments, each of the multiple partitions may include a processor executing an instance of an operating system. In certain embodiments, the operations may include running different operating systems on at least two of the multiple partitions.

In certain embodiments, the operations may include performing hardware virtualization while the multi-partition configuration is active. In certain embodiments, the operations may include running a virtual machine on at least one partition while the multi-partition configuration is active. In some embodiments, at least one of the plurality of partition configurations includes a multi-socket configuration. In some embodiments, the operations further include storing a computer image associated with each of the plurality of partition configurations. In some embodiments, associating the configuration schedule with the plurality of partition configurations includes dividing a day into a plurality of timeframes and assigning each of the plurality of timeframes to one of the plurality of partition configurations.

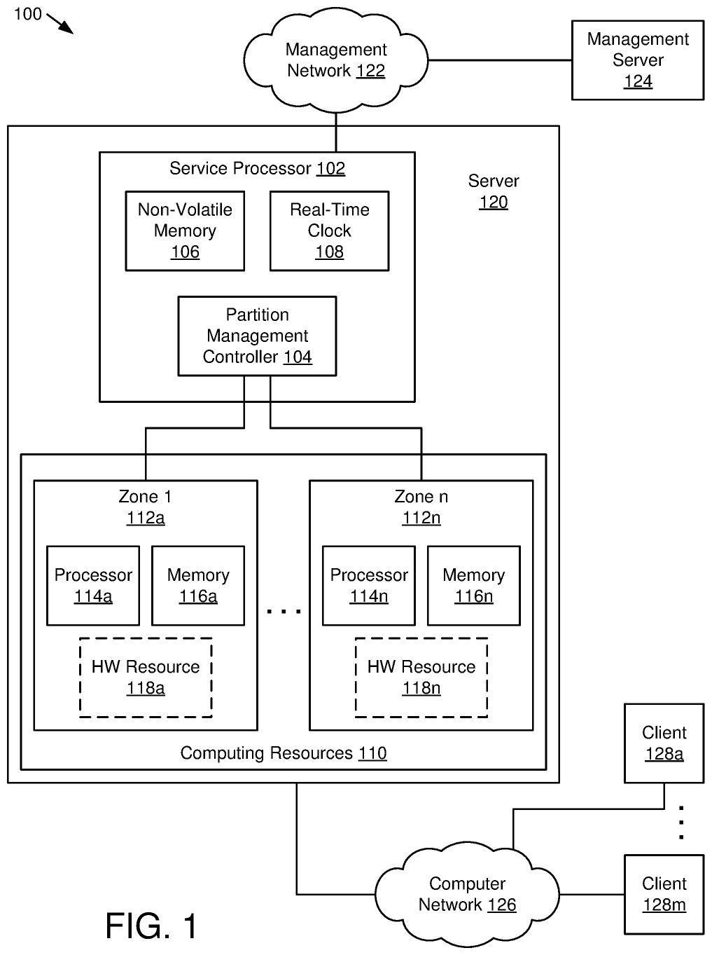

FIG. 1 illustrates a system 100 for automatically switching between operating modes at a scheduled time period, according to various embodiments. The system 100 includes a service processor 102 with a partition management controller 104, a non-volatile memory 106, and a real-time clock 108. In some embodiments, the service processor 102 and the computing resources 110 are within a server 120. The server 120 may execute workloads on the computing resources 110 for various clients 128a-128m (collectively or generically “128”) in communication with the server 120 over a computer network 126.

The system 100 includes a set of apportionable computing resource 110 a subset of which includes 1st-nth allocable zones 112a-112n (generically or collectively “112”). In various embodiments, each allocable zone includes at least one processor (e.g., a central processing unit (“CPU”)) labeled processor 114a to 114n (generically or collectively “114”). Each of the n zones 112 may also include a variety of components, such as memory 116a-116n (generically or collectively “116”) and other hardware (“HW”) resources 118a-118n (generically or collectively “118”). Example of HW resources 118 include, but are not limited to, a non-volatile storage device, a graphical processing unit (“GPU”), an accelerator, another processor, a FPGA, an Input/Output (“I/O”) device, a universal serial bus (“USB”) controller, and the like. Note that the apportionable computing resources 110 may include one or more resources that are not assigned to any zone 112.

In some embodiments, the zones 112 are created by partitioning a motherboard with multiple sockets (e.g., multiple processors 114). In some embodiments, each of the one or more of zones 112 runs a different instance of an operating system (“OS”). In certain embodiments, each of the plurality of zones 112 is connected to the service processor 102 via the partition management controller 104, which configures resource allocation settings to implement a particular operating mode, also referred to as a partition configuration.

In various embodiments, a partition configuration includes parameters and settings to allocate the computing resources 110 into one or more partitions. In certain embodiments, a particular partition configuration may allocate the computing resources 110 into a single partition. In other embodiments, a particular partition configuration may allocate the computing resources 110 into multiple partitions. Here, each partition may be allocated to a particular client 128, e.g., for performing a workload. As used herein, a partition refers to a logical division of the computing resources 110 that is treated as a separate unit, where each partition is capable of concurrent and independent operation. For example, each partition may be capable of running an operating system independently of any other partition. A “partition configuration,” as used herein, refers to a set of links, settings, parameters, etc. that defines the partitioning of a system, such as the computing system 100. In contrast to partitioning the computing system 100 into multiple partitions, the term “single partition” refers to a configuration where the computing resources 110 are not divided, i.e., where portioning is removed. In certain embodiments, a “single partition” configuration may also be referred to as a “single system” configuration.

“Partitioning.” as used herein, refers to an action of controllably and reversibly dividing a multi-processor system into parts or sections of the whole system. The parts or sections that result from the action of partitioning may be referred to as “partitions” or “partitioned nodes.” For example, a multi-processor system may be operated as a single unified node (e.g., a “single partition” or “single system” configuration) or divided into two or more partitioned nodes (e.g., a “multi-partition” configuration), where each partition includes at least one CPU and operates independent of any other partitioned node within the same multi-processor system. Embodiments may also include partitioning of other resources of the multi-processor system beside the CPUS, such as the data storage devices, memory devices and/or I/O devices.

In some embodiments, each partition includes at least one zone 112. In some embodiments, the partition may be a hard partition where discrete components are allocated to different partitions without sharing a computing resource 110 between multiple partitions. In other embodiments, one partition may share a computing resource 110 with another partition. Note, however, that partitioning the computing system 100 into multiple partitions does not require that each partition be equal, i.e., including the same number and/or types of computing resources 110. In fact, one partition may include more powerful computing resources 110, a greater number of computing resources 110, etc. than another partition running concurrently on the computing system 100.

In certain embodiments, a partition configuration does not include an allocation for every computing resource 110. For example, one or more computing resources may be unassigned in a particular partition configuration. In certain embodiments, any unassigned computing resource 110 is considered a shared resource available to all partitions of the partition configuration. In other embodiments, any unassigned computing resource 110 is considered an inactive resource that is not available to any partition of the partition configuration.

In various embodiments, the service processor 102 is configured to store configurations for various operating modes of the computing system 100. For example, each operating mode may be associated with a partition configuration that allocates the computing resources 110 of the computing system 100 to particular clients 128. In certain embodiments, the service processor 102 stores the configurations in the non-volatile memory 106.

The service processor 102 may be configured to associate a configuration schedule with the plurality of partition configurations, where each of the plurality of partition configurations is associated with a scheduled time period. In various embodiments, the service processor 102 is configured to boot the computing system to a particular partition configuration at a scheduled time period corresponding to the particular partition configuration. For example, the service processor 102 may track a current time via the real-time clock 108 and switch to the scheduled partition configuration at the appropriate time, as indicated by the configuration schedule. In some embodiments, the service processor 102 may periodically check the time frame to determine if a particular time block or specific time set of the next partition configuration is reached. Then, at the assigned time, the service processor 102 may reboot the server 120 but pointing to the next partition configuration, so when the server 120 is back online it will be partitioned differently. For example, the server 120 may access a different OS drive, potentially to boot the system into that particular OS.

The real-time clock 108 measures the passage of time, thereby allowing accurate tracking of the time-of-day. In some embodiments, the real-time clock 108 includes an integrated circuit embedded in—or coupled with—the service processor 102. In contrast to a hardware clock which outputs a clock signal for the function of synchronous digital circuits, such as microprocessors and other integrated circuits requiring synchronized switching, the real-time clock 108 tracks the time of day, e.g., using human-perceivable units, such as seconds, minutes, hours, etc.

In some embodiments, at least one of the plurality of partition configurations involves a multi-partition configuration having multiple partitions. In such embodiments, the computing resources 110 of the computing system 100 are shared among the multiple partitions. In some embodiments, each of the multiple partitions contains a processor 114 executing an instance of an OS.

In some embodiments, the computing system 100 runs different operating systems on at least two of the multiple partitions while the multi-partition configuration is active. In certain embodiments, the computing system 100 runs a virtual machine on at least one partition while the multi-partition configuration is active. In certain embodiments, the computing system 100 supports hardware virtualization while the multi-partition configuration is active.

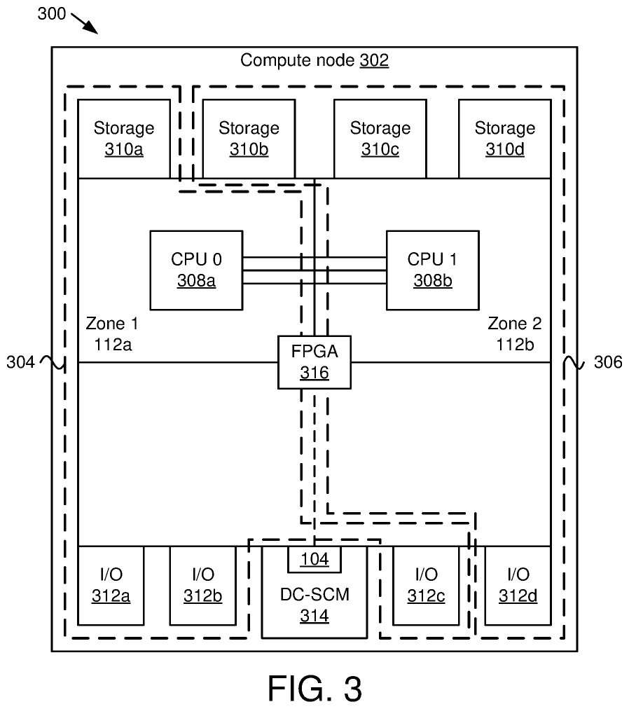

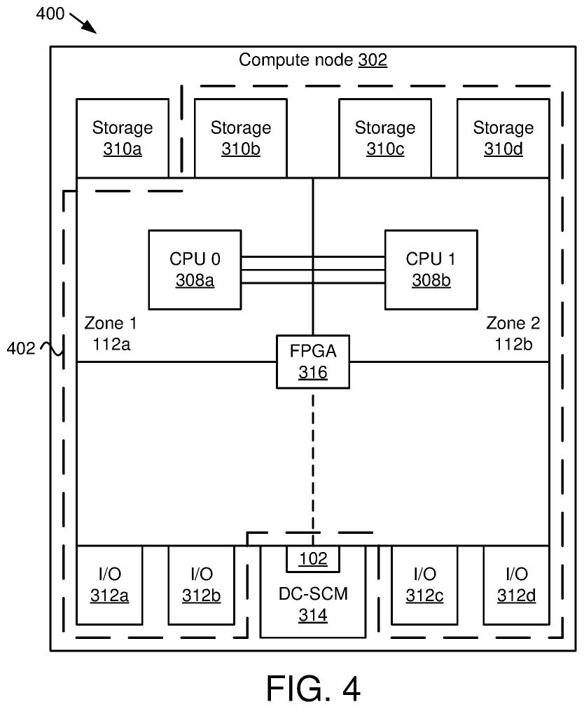

In some embodiments, at least one partition configuration of the plurality of partition configurations involves a multi-socket configuration. In such embodiments, the computing resources 110 of the computing system 100 are allocated to a single partition. In some embodiments, the computing system 100 supports hardware virtualization while the multi-socket configuration is active. A common configuration of a computing resources 110 includes two sockets, as depicted in FIGS. 3-4, where each socket can accommodate a processor 114 (e.g., a CPU) and where each processor 114 is supported by memory 116 and other components.

In some embodiments, the service processor 102 embodies a baseboard management controller (“BMC”). In other embodiments, the service processor 102 embodies a Datacenter-ready Secure Control Module (“DC-SCM”). In some embodiments, the service processor 102 is an XClarity® Controller (“XCC”) by Lenovo®. The service processor 102, in some embodiments, is in communication with a management server, which may be at the site of a server or other computing device with the service processor 102 or may be remote and accessible over a management network. In some embodiments, the management server is an XClarity Administrator (“XCA”) or an XClarity Orchestrator (“XCO”), both by Lenovo.

In some embodiments, the service processor 102 and the computing resources 110 are located on the same motherboard. In other embodiments, the service processor 102 is in a separate computing device and may be communicatively coupled to the computing resources 110, e.g., via a wired network connection.

In some embodiments, the service processor 102 is connected to a management server 124 over a management network 122. The management network 122, in some embodiments, is a network different than the computer network 126 used for communication with clients 128a-128m, for communication of data from workloads running on the server 120, etc. In other embodiments, the management network 122 uses the same computer network 126, but runs securely.

The computer network 126 and/or management network 122 may include a LAN, a WAN, a fiber network, a wireless connection, the Internet, etc. and may include multiple networks. The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In certain embodiments, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

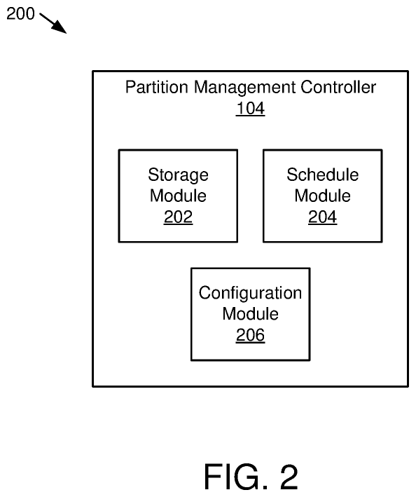

FIG. 2 depicts an exemplary apparatus 200 for automatically switching between partition configurations at a scheduled time period, according to embodiments of the disclosure. In various embodiments, the apparatus 200 includes an embodiment of the partition management controller 104. In some embodiments, all or a portion of the apparatus 200 is implemented with executable code stored on computer readable storage media, which is non-transitory. In other embodiments, all or a portion of the apparatus 200 is implemented using a programmable hardware device and/or hardware circuits.

The partition management controller 104 includes a storage module 202 configured to a plurality of partition configurations for the computing system 100. In some embodiments, the storage module 202 stores a computer image associated with each of the plurality of partition configurations. As described above with reference to FIG. 1, a partition configuration includes parameters and settings to allocate the computing resources 110 into one or more partitions (e.g., logical divisions of the computing resources 110 capable of concurrent and independent operation).

In various embodiments, the plurality of partition configurations allocates the computing resources 110 of the computing system 100 to clients 128. In some embodiments, at least one partition configuration of the plurality of partition configurations involves a multi-socket configuration (e.g., a single system configuration). In some embodiments, at least one of the plurality of partition configurations involves a multi-partition configuration having multiple partitions.

The partition management controller 104 includes a schedule module 204 configured to associate a configuration schedule with the plurality of partition configurations. In various embodiments, the configuration schedule allocates time resources to plurality of partition configurations, such that each of the plurality of partition configurations is associated with a scheduled time period.

In some embodiments, the schedule module 204 is configured to divide a day into multiple timeframes (e.g., hours or fractions thereof) and to assign each timeframe to one of the plurality of partition configurations. In certain embodiments, the schedule module 204 may divide a week or multi-week period (e.g., month), or longer time period into smaller timeframes (e.g., day or hour or fractions thereof) and derive a one or more configuration schedules for the week, month, etc. Here, the configuration schedule(s) do not need to be the same timing for each day; rather, the configuration schedule(s) may vary according to the day of the week, the calendar date, etc. In other embodiments, the schedule module 204 may divide an hour, a multi-hour window, or longer time period into smaller timeframes (e.g., minutes or fractions thereof) and derive a one or more configuration schedules for the hour, multi-hour window, etc. Here, the configuration schedule(s) may also vary according to the hour of the day, etc.

In certain embodiments, the configuration schedule includes a transition time for switching from one partition configuration to the next. Note that the configuration schedule may be a semi-static schedule, e.g., assumed to run indefinitely until changed by a system administrator or other user.

The partition management controller 104 includes a configuration module 206 configured to boot the computing system 100 to a particular partition configuration at a particular scheduled time period corresponding to the particular partition configuration. In certain embodiments, the configuration module 206 is configured to monitor the real-time clock 108 and to re-boot the computing system 100 to the particular partition configuration at the particular scheduled time period is based on an output of the real-time clock 108.

In some embodiments, the configuration module 206 is configured to perform a graceful shut down the computing system 100 at a predetermined time prior to a beginning of a next scheduled time period (e.g., at the beginning of the transition time) and to switch to the particular partition configuration once the computing system 100 is shutdown. As used herein, a graceful shutdown is when the computing system 100 is turned off by software function and the OS is allowed to perform its tasks of safely shutting down processes and closing connections. In contrast, a hard shutdown refers to an event where the computing system 100 is forcibly shut down, e.g., by interruption of power.

In certain embodiments, the computing system 100 includes a FPGA coupled to the partition management controller 104. In such embodiments, shutting down the computing system 100 at the predetermined time includes signaling the FPGA to power down each active partition (i.e., triggering a graceful shut down of the active partition(s)) and to reconfigure the computing system 100 after the shutdown according to the particular partition configuration. In various embodiments, the configuration module 206 is configured to re-boot the computing system 100 after switching to the particular configuration, thereby changing the computing system 100 into an operational state that uses a different operating mode than before the shutdown. In certain embodiments, booting to the next partition configuration grants a different client access to the computing resources 110.

In some embodiments, a partition configuration (or a partition thereof) is associated with a particular computer image or disk image. In such embodiments, re-booting the computing system 100 after reconfiguring to the next partition configuration (e.g., operating mode) includes accessing a disk image corresponding to the next partition configuration and booting the computing system 100 using the corresponding disk image. In various embodiments, the corresponding disk image (i.e., computer image) may include an operating system, utilities, applications, application data, and/or boot data.

In some embodiments, the apparatus 200 includes a service processor, such as the service processor 102 described above in relation to FIG. 1. In certain embodiments, the apparatus 200 embodies a BMC. In other embodiments, the apparatus 200 embodies a DC-SCM. For example, the partition management controller 104 may be a component of a BMC and/or a DC-SCM.

FIG. 3 depicts an operating mode 300 that may be automatically switched to at a scheduled time period, according to various embodiments. The operating mode 300 represents a specific resource configuration of a computer node 302, which may be one embodiment of the computing system 100. In various embodiments, the compute node 302 includes at least two zones, including a first zone 112a (denoted “Zone 1”) including a first CPU 308a (denoted “CPU 0”) and a second zone 112b (denoted “Zone 2”) including a second CPU 308b (denoted “CPU 1”). The first CPU 308a and second CPU 308b may be embodiments of the processors 114.

The compute node 302 includes additional hardware resources, including a set of storage devices 310a-310d (generically or collectively “310”) and a set of I/O devices/controllers 312a-312d (generically or collectively “312”). Additionally, the compute node 302 includes a DC-SCM 314, which may be one embodiment of the service processor 102 described above in relation to FIG. 1. Moreover, the compute node 302 includes a partition management controller 104, which may be part of a DC-SCM 314. In certain embodiments, the partition management controller 104 is coupled to an FPGA 316 which implements various resource allocation settings to apply the operating mode 300.

The FPGA 316, in some embodiments, facilitates partitioning the compute node 302 into zones 112. In some embodiments, the FPGA 316 partitions the compute node 302 so that each zone 112 includes a CPU 308, memory, and—optionally—additional hardware resources including one or more storage devices 310, one or more I/O devices/controllers 312, etc. In some embodiments, the FPGA 316 may configure the compute node 302 according to an active partition configuration, e.g., configuring the compute node 302 into a single system or removing partitions. In certain embodiments, the FPGA 316 facilitates communication between the partition management controller 104 and the zones 112.

In some embodiments, the DC-SCM 314 is a management controller compliant with an open source specification. In certain embodiments, the DC-SCM 314 complies with a DC-SCM specification, such as the DC-SCM 2.0 specification. In some embodiments, the DC-SCM 314 includes a BMC and is connected to a management network 122. Typically, a DC-SCM 314 includes a BMC plus other supporting components, such as memory, buses, bus controllers, a GPU, and the like. In some embodiments, the DC-SCM 314 is a card in a dedicated slot on a motherboard of the compute node 302, where the slot complies with a DC-SCM specification.

The partition management controller 104 includes a storage module 202, a schedule module 204, and a configuration module 206 which are substantially similar to those described above in relation to the apparatus 200 of FIG. 2. The storage module 202, the schedule module 204, and the configuration module 206 are not shown for convenience but are included.

In the operating mode 300, the hardware resources of the compute node 302 are allocated into two partitions: a first partition 304 and a second partition 306. Accordingly, the operating mode 300 may be one instance of a multi-partition partition configuration. In the depicted embodiment, the first partition 304 is allocated the first CPU 308a, the storage device 310a, the I/O device/controller 312a, the I/O device/controller 312b, and the I/O device/controller 312c. In the depicted embodiment, the second partition 306 is allocated the second CPU 308b, the storage device 310b, the storage device 310c, the storage device 310d, and the I/O device/controller 312d. While specific allocations are shown in FIG. 3, in other embodiments the hardware resources of the compute node 302 may be allocated differently when in the operating mode 300.

In some embodiments, a hardware resources of the partitions may overlap. For example, the first partition 304 may have share the same GPU or accelerator as the second partition 306. This scenario is particularly beneficial when a compute node 302 has multiple CPUs, but only one GPU, accelerator, digital signal processor (“DSP”), etc. When sharing a common hardware resource (e.g., GPU), the partition management controller may be configured to allocate computing time of the shared hardware resource to the first partition 304 and to the second partition 306, for example, according to time-sharing principles (e.g., round-robin scheduling), priority-based scheduling (e.g., based on user/client priority and/or task priority), quota-based scheduling, reservation-based scheduling, and/or other resource scheduling schemas known in the art.

FIG. 4 depicts another operating mode 400 that may be automatically switched to at a scheduled time period. The operating mode 400 also represents a specific resource configuration of a computer node 302, which may be one embodiment of the computing system 100. The compute node 302 includes the same hardware resources described above with reference to FIG. 3, including an instance of the partition management controller 104, which may be part of the DC-SCM 314. In certain embodiments, the partition management controller 104 is coupled to an FPGA 316 which implements various resource allocation settings to apply the operating mode 400.

In the operating mode 400, the hardware resources of the compute node 302 are allocated into a single partition 402 (i.e., a single-system configuration). Accordingly, the operating mode 400 may be one instance of a multi-socket partition configuration (e.g., 2S configuration), as both the first CPU 308a and the second CPU 308b are allocated to the single partition 402. Moreover, the storage devices 310b-310d and the I/O devices/controllers 312a-312d are all allocated to the single partition 402. While specific allocations are shown in FIG. 4, in other embodiments the hardware resources of the compute node 302 may be allocated differently when in the operating mode 400.

In the depicted embodiment, there is at least one hardware resource (i.e., the storage device 310a) that is not allocated to the single partition 402 and thus may be an inactive resource that may be powered down or otherwise inaccessible while the single partition 402 is active. For example, the storage device 310a may contain user data, an operating system, a virtual machine image, or other data that should not be accessible when the single partition 402 is active.

As depicted in FIGS. 3-4, various hardware resources may overlap between different partition configurations. Moreover, each partition configuration may be associated with the same or different clients. For example, a first client may be associated with the first partition 304, while a second client may be associated with the second partition 306 and the single partition 402. When the compute node 302 operates in the operating mode 300, both the first and second clients have access to different partitions of the compute node 302. However, when the compute node 302 operates in the operating mode 400, the second client has access to a third partition having more system resources and therefore may be able to perform computing tasks requiring increases computing power and/or may more quickly perform computing tasks.

In various embodiments, the same hardware resource (e.g., computing resource 110) may be used by multiple partitions. Example resources that may be used by multiple partitions include a CPU, a storage device, and the like. For example, the first CPU 308a may be in the first partition 304 during a first time block and may be in the single partition 402 during a second time block. Accordingly, the computing system 100 is not statically partitioned, but can bring different partitions on-line at different times reuse some of the same computing resources at different times in different partitions.

Beneficially, by having multiple partition configurations, the compute node 302 has flexibility to offer different configuration of the computing resources, e.g., by providing multiple partitions during one time and providing increased performance during another time. In some embodiments, having multiple partition configurations allows the compute node 302 to customize the availability of computing resource such that clients are only allocated those computing resources they need and for only as long as they need. Accordingly, automatically switching between partition configurations by schedule allows for dual use of resources because of the unique transitions.

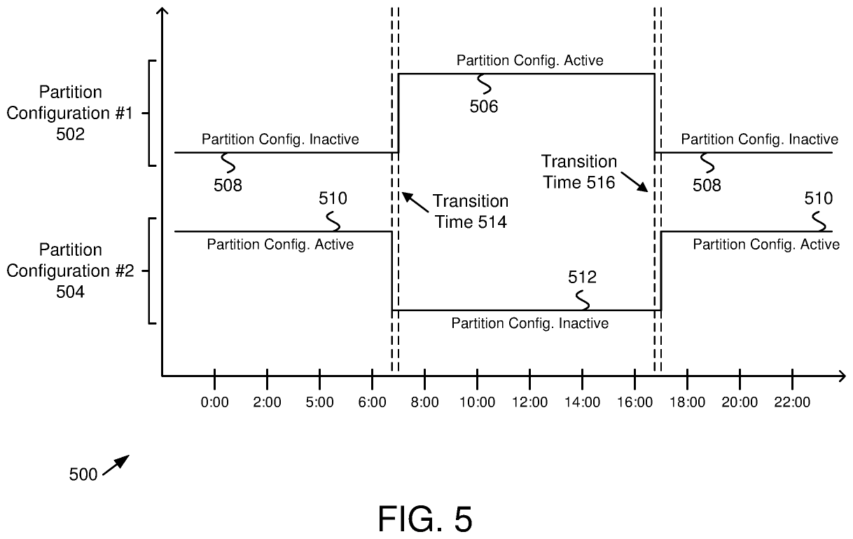

FIG. 5 depicts an exemplary configuration schedule 500 for automatically switching between partition configurations at a scheduled time period, according to embodiments of the disclosure. The configuration schedule 500 depicts active and inactive times for a plurality of partition configurations. In the depicted embodiment, two partition configurations (i.e., first partition configuration 502 and second partition configuration 504) are on the configuration schedule 500; however, in other embodiments the configuration schedule 500 may schedule more than two partition configurations.

The first partition configuration 502 includes a first active time 506 and a first inactive time 508. During the first active time 506, the computing system (e.g., the computing system 100 and/or the compute node 302) is to be configured according to the first partition configuration 502. During the first inactive time 508, the computing system is not to operate in the first partition configuration 502.

An example of a first partition configuration 502 is described above with reference to FIG. 3. Alternatively, the first partition configuration 502 could be as described above with reference to FIG. 4. In other embodiments, the first partition configuration 502 may have a different number of partitions and/or different allocation of system resources than shown in FIGS. 3-4.

The second partition configuration 504 includes a second active time 510 and a second inactive time 512. During the second active time 510, the computing system is to be configured according to the second partition configuration 504. During the second inactive time 512, the computing system is not to operate in the second partition configuration 504.

An example of a second partition configuration 504 is described above with reference to FIG. 3. Alternatively, the second partition configuration 504 could be as described above with reference to FIG. 4. In other embodiments, the second partition configuration 504 may have a different number of partitions and/or different allocation of system resources than shown in FIGS. 3-4. In some embodiments, the first configuration partition 502 is the partition configuration of FIG. 3 while the second configuration partition 504 is the partition configuration of FIG. 4.

In the depicted embodiment, the first partition configuration 502 becomes active at approximately 7:00 hours and the second partition configuration 504 becomes active at approximately 17:00 hours. Thus, the computing system operates according to the first partition configuration 502 from 7:00 hours until a predetermined time before 17:00 hours and the computing system operates according to the second partition configuration 504 from 17:00 hours until a predetermined time before 7:00 hours the following day.

While the depicted configuration schedule 500 assumes the same timing for each day, in other embodiments the configuration schedule 500 may vary according to the day of the week, the calendar date, the season, etc. For example, the first partition configuration 502 and the second partition configuration 504 may be scheduled during workdays, while the second partition configuration 504 and/or a third (or fourth) partition configuration may be scheduled for weekends, holidays, etc.

During a first transition time 514, the computing system transitions from the second partition configuration 504 to the first partition configuration 502. During a second transition time 516, the computing system transitions from the first partition configuration 502 to the second partition configuration 504. Within each transition time 514, 516, the service processor may initiate graceful shutdown of each partition associated with the active partition configuration and reconfiguring resource allocation settings in accordance with the next scheduled partition configuration. Then, the service processor may re-boot the computing system in the new partition configuration such that the new partition configuration is active at the end of the transition time 514, 516.

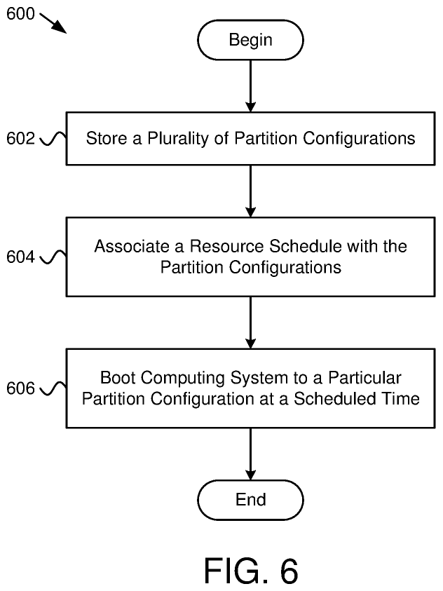

FIG. 6 depicts a method 600 for automatically switching between partition configurations at a scheduled time period, according to embodiments of the disclosure. The operations of the method 600 may be implemented by a service processor embedded in or coupled to a computing system 100. Examples of the service processor include, but are not limited to, the service processor 102, the partition management controller 104, the apparatus 200 (or components thereof), the DC-SCM 314, a BMC, or other management controller. Additionally, or alternatively, the operations of the method 600 may be performed by a processor executing program code, for example, a microcontroller, a microprocessor, a CPU, a GPU, an auxiliary processing unit, a FPGA, or the like.

The method 600 begins and stores 602 a plurality of partition configurations for a computing system. Here, the plurality of partition configurations allocate hardware resources of the computing system. The method 600 associates 604 a configuration schedule with the plurality of partition configurations. Here, each of the plurality of partition configurations is associated with a scheduled time period.

The method 600 boots 606 (or re-boots) the computing system to a particular partition configuration at a particular scheduled time period corresponding to the particular partition configuration and the method ends. In various embodiments, all or a portion of the method 600 is implemented using the storage module 202, the schedule module 204, and/or the configuration module 206.

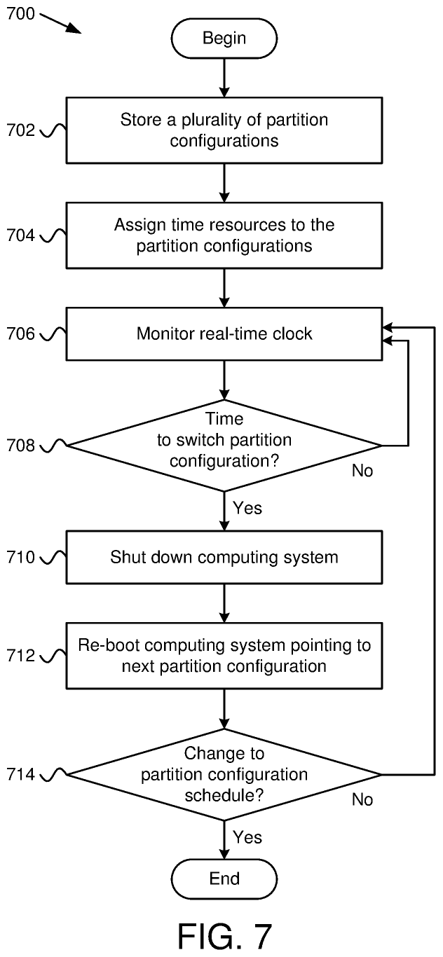

FIG. 7 depicts a method 700 for automatically switching between partition configurations at a scheduled time period, according to embodiments of the disclosure. The operations of the method 700 may be implemented by a service processor embedded in or coupled to a computing system 100. Examples of the service processor include, but are not limited to, the service processor 102, the partition management controller 104, the apparatus 200 (or components thereof), the DC-SCM 314, a BMC, or other management controller. Additionally, or alternatively, the operations of the method 700 may be performed by a processor executing program code, for example, a microcontroller, a microprocessor, a CPU, a GPU, an auxiliary processing unit, a FPGA, or the like.

The method 700 begins and stores 702 a plurality of partition configurations for a computing system. In some embodiments, each partition configuration indicates a distribution of hardware resources of the computing system. In certain embodiments, multiple partitions are active at the same time for a respective partition configuration. In other embodiments, only a single partition is active for a respective partition configuration.

The method 700 assigns 704 recurring time resources to each of the plurality of partition configurations, e.g., according to a configuration schedule. In certain embodiments, assigning 704 the recurring time resources includes designating transition times for switching from one partition configuration to the next. In certain embodiments, the assignment of recurring time resources schedules blocks of time on a daily or weekly basis.

The method 700 monitors 706 a real-time clock. In certain embodiments, the service processor is a BMC, DC-SCM, or similar controller and the real-time clock is a part of the service processor. In certain embodiments, monitoring 706 the real-time clock includes setting one or more timers or other event-based triggers related to the transition times for switching from one partition configuration to the next.

The method 700 determines 708 whether the real-time clock indicates that it is time to switch the partition configuration. If the method 700 determines 708 that the real-time clock does not indicate a time to switch the partition configuration, then the method 700 returns and monitors 706 the real-time clock.

However, when the method 700 determines 708 that the real-time clock indicates that it is time to switch the partition configuration, then the method 700 proceeds to shut down 710 the computing system. In some embodiments, the method 700 interfaces with an FPGA on the motherboard to shut down 710 the computing system. For example, the FPGA may include a power button source, whereby the method 700 uses Advanced Configuration and Power Interface (“ACPI”) commands to cause one or more active OSes to gracefully shut down.

The method 700 re-boots 712 the computing system pointing to a next partition configuration. In certain embodiments, the method 700 waits until all active partitions are shut down (i.e., powered off) and then reconfigures the computing system according to the next partition configuration before re-booting 712 the computing system in the new partition configuration.

The method 700 determines 714 whether the operator (i.e., a system administrator or other user) has made any changes to the configuration schedule. If the method 700 determines 714 that the operator has made changes to the configuration schedule, then the method 700 exits/ends-alternatively, the method 700 may restart. Otherwise, if the method 700 determines 714 that the operator has not made any changes to the configuration schedule, then the method 700 returns and monitors 706 the real-time clock. In various embodiments, all or a portion of the method 700 is implemented using the storage module 202, the schedule module 204, and/or the configuration module 206.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
storing, at a service processor, a plurality of partition configurations for a computing system, the plurality of partition configurations allocating hardware resources of the computing system;
associating a configuration schedule with the plurality of partition configurations, wherein each of the plurality of partition configurations is associated with a scheduled time period; and
booting the computing system to a particular partition configuration at a particular scheduled time period corresponding to the particular partition configuration.

2. The method of claim 1, further comprising running a real-time clock (“RTC”) at the service processor, wherein booting the computing system to the particular partition configuration at the particular scheduled time period is based on an output of the RTC.

3. The method of claim 1, wherein booting the computing system to the particular partition configuration at the particular scheduled time period comprises shutting down the computing system at a predetermined time prior to a beginning of a next scheduled time period, switching to the particular partition configuration, and re-booting the computing system.

4. The method of claim 3, wherein the computing system comprises a Field Programmable Gate Array (“FPGA”) coupled to the service processor, wherein shutting down the computing system at the predetermined time comprises signaling the FPGA to power down an active partition and to reconfigure computing system according to the particular partition configuration.

5. The method of claim 1, wherein at least one of the plurality of partition configurations comprises a multi-partition configuration having multiple partitions, wherein the hardware resources of the computing system are shared among the multiple partitions.

6. The method of claim 5, wherein each of the multiple partitions comprises a processor executing an instance of an operating system.

7. The method of claim 6, further comprising running different operating systems on at least two of the multiple partitions.

8. The method of claim 5, further comprising performing hardware virtualization while the multi-partition configuration is active and/or running a virtual machine on at least one partition while the multi-partition configuration is active.

9. The method of claim 1, wherein at least one of the plurality of partition configurations comprises a multi-socket configuration.

10. The method of claim 1, wherein associating the configuration schedule with the plurality of partition configurations comprises dividing a day into a plurality of timeframes and assigning each of the plurality of timeframes to one of the plurality of partition configurations.

11. The method of claim 1, wherein storing the plurality of partition configurations comprises storing a computer image associated with each of the plurality of partition configurations.

12. The method of claim 1, wherein the service processor comprises a datacenter-ready secure control module (“DC-SCM”) or a baseboard management controller (“BMC”).

13. An apparatus comprising:
a processor; and
a non-transitory computer readable storage media storing code, the code being executable by the processor to perform operations comprising:
storing, at a service processor, a plurality of partition configurations for a computing system, the plurality of partition configurations allocating hardware resources of the computing system;
associating a configuration schedule with the plurality of partition configurations, wherein each of the plurality of partition configurations is associated with a scheduled time period; and
booting the computing system to a particular partition configuration at a particular scheduled time period corresponding to the particular partition configuration.

14. The apparatus of claim 13, the operations further comprising:
running a real-time clock (“RTC”) at the service processor, wherein booting the computing system to the particular partition configuration at the particular scheduled time period is based on an output of the RTC.

15. The apparatus of claim 13, wherein booting the computing system to the particular partition configuration at the particular scheduled time period comprises shutting down the computing system at a predetermined time prior to a beginning of a next scheduled time period, switching to the particular partition configuration, and re-booting the computing system.

16. The apparatus of claim 15, further comprising a Field Programmable Gate Array (“FPGA”) coupled to the service processor, wherein shutting down the computing system at the predetermined time comprises signaling the FPGA to power down an active partition and to reconfigure computing system according to the particular partition configuration.

17. The apparatus of claim 13, wherein at least one of the plurality of partition configurations comprises a multi-partition configuration having multiple partitions, wherein the hardware resources of the computing system are shared among the multiple partition, and wherein each of the multiple partitions comprises a processor executing an instance of an operating system.

18. The apparatus of claim 13, wherein at least one of the plurality of partition configurations comprises a multi-socket configuration, wherein storing the plurality of partition configurations comprises storing a computer image associated with each of the plurality of partition configurations.

19. The apparatus of claim 13, wherein associating the configuration schedule with the plurality of partition configurations comprises dividing a day into a plurality of timeframes and assigned each of the plurality of timeframes to one of the plurality of partition configurations.

20. A program product comprising a non-transitory computer readable storage medium storing code, the code being configured to be executable by a processor to perform operations comprising:
storing, at a service processor, a plurality of partition configurations for a computing system, the plurality of partition configurations allocating hardware resources of the computing system;
associating a configuration schedule with the plurality of partition configurations, wherein each of the plurality of partition configurations is associated with a scheduled time period; and
booting the computing system to a particular partition configuration at a particular scheduled time period corresponding to the particular partition configuration.
